(19) United States
(12) Patent Application Publication
(10) Pub. No.: US 2026/0100095 A1
(43) Pub. Date: Apr. 9, 2026

(54) LOW LATENCY STREAMING IN ELECTRONIC GAMES

(71) Applicant: IGT, Las Vegas, NV (US)

(72) Inventor: Andreas Bean, Graz (AT)

(21) Appl. No.: 19/348,430

(22) Filed: Oct. 2, 2025

Related U.S. Application Data
(60) Provisional application No. 63/703,458, filed on Oct. 4, 2024.

(51) Int. Cl. G07F 17/32

(52) U.S. Cl. CPC G07F 17/323; G07F 17/322

(57) ABSTRACT

Embodiments are directed to low latency streaming of video in an electronic game such as an electronic table game. According to one embodiment, a gaming system can comprise a Central Processing Unit (CPU), a Graphics Processing Unit (GPU), and a memory coupled with and readable by the CPU and the GPU and storing therein a set of instructions which, when executed by the CPU, causes the CPU to receive, from a camera, an encoded video stream representing elements of an electronic game, and provide, to the GPU, the encoded video stream. The set of instructions, when executed by the GPU, can cause the GPU to receive the encoded video stream from the CPU, decode the encoded video stream, sample a plurality of frames from the decoded video stream, and save the sampled plurality of frames from the decoded video stream in a buffer maintained within the GPU.

### CROSS-REFERENCE TO RELATED APPLICATIONS

The present application claims the benefit of and priority, under 35 U.S.C. § 119(e), to U.S. Provisional Application Serial No. 63/703,458, filed on October 4, 2024, entitled “Low Latency Streaming in Electronic Table Games,” the entire disclosure of which is hereby incorporated herein by reference, in its entirety, for all that it teaches and for all purposes.

### BACKGROUND

The present disclosure is generally directed to video streaming and more particularly to low latency streaming of video in an electronic game such as an electronic table game.

Video streaming is used in electronic game to share views of game surfaces and elements. For example, in electronic table games such as craps or roulette, a camera can capture and stream a view of the table and dice or wheel to be streamed to and displayed on player terminal devices. However, ultra-low latency streaming is not easy to achieve. On one hand, the camera must send the video frames quickly enough, the network connection must be fast enough, and finally, decoding and displaying must function very quickly. This is referred to as glass-to-glass latency, which means the time from when the light hits the camera to when the camera image is displayed on the screen, i.e., in the game. Previous implementations utilize an input buffer and, after decoding the video frames by a graphics card, the frames are transferred to the main memory again. Then each frame is sent from the video decoder to the game and uploaded onto the graphics card again. This back and forth transfer of frames creates a significant amount of latency.

### BRIEF SUMMARY

Embodiments of the present disclosure are directed to low latency streaming of video in an electronic game such as an electronic table game. According to one embodiment, a gaming system can comprise a Central Processing Unit (CPU), a Graphics Processing Unit (GPU), and a memory coupled with and readable by the CPU and the GPU. The memory can store therein a set of instructions which, when executed by the CPU, causes the CPU to receive, from a camera, an encoded video stream representing elements of an electronic game and provide, to the GPU, the encoded video stream. The set of instructions, when executed by the GPU, can cause the GPU to receive the encoded video stream from the CPU, decode the encoded video stream, and save frames of the decoded video stream in a buffer maintained within the GPU. The instructions can further cause the CPU to select a frame from the buffer and provide the selected frame as a frame of an output stream of the electronic game.

The buffer within the GPU can comprise a ring buffer of a fixed size. For example, the fixed size comprises five frames. A time between providing the selected frame as a frame of an output stream of the electronic game can be less than 30 milliseconds. For example, the time between provide the selected frame as a frame of an output stream of the electronic game can be 50 milliseconds. In some cases, the electronic game can comprise an electronic table game.

According to another embodiment, an Electronic Table Game (ETG) system can comprise a CPU, a GPU, and a memory coupled with and readable by the CPU and the GPU. The memory can store therein a set of instructions which, when executed by the CPU, causes the CPU to receive, from a camera, an encoded video stream representing elements of an electronic game and provide, to the GPU, the encoded video stream. The set of instructions, when executed by the GPU, can cause the GPU to receive the encoded video stream from the CPU, decode the encoded video stream, and save frames of the decoded video stream in a buffer maintained within the GPU. The instructions can further cause the CPU to select a frame from the buffer and provide the selected frame as a frame of an output stream of the electronic game.

The buffer within the GPU can comprise a ring buffer of a fixed size. For example, the fixed size comprises five frames. A time between providing the selected frame as a frame of an output stream of the electronic game can be less than 30 milliseconds. For example, the time between provide the selected frame as a frame of an output stream of the electronic game can be 50 milliseconds.

According to yet another embodiment, a method for operating an electronic game can comprise receiving, by a CPU of a gaming system, from a camera, an encoded video stream representing elements of an electronic game and providing, by the CPU of the gaming system, to a GPU of the gaming system, the encoded video stream. The encoded video stream can be received by the GPU the from the CPU, the received video stream can be decoded by the GPU, and frames of the decoded video stream can be saved by the GPU in a buffer maintained within the GPU. Aa frame can be selected from the buffer by the CPU and the CPU can provide the selected frame as a frame of an output stream of the electronic game.

The buffer within the GPU can comprise a ring buffer of a fixed size. For example, the fixed size comprises five frames. A time between providing the selected frame as a frame of an output stream of the electronic game can be less than 30 milliseconds. For example, the time between provide the selected frame as a frame of an output stream of the electronic game can be 50 milliseconds. In some cases, the electronic game can comprise an electronic table game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure may be implemented.

FIG. 2 is a block diagram illustrating additional details of elements of an environment in which embodiments of the present disclosure may be implemented according to one embodiment of the present disclosure.

FIG. 3 is a block diagram illustrating additional details of components of a gaming system according to one embodiment of the present disclosure.

FIG. 4 is a flowchart illustrating an exemplary process for operating an electronic game according to one embodiment of the present disclosure.

FIG. 5 is a flowchart illustrating an exemplary process for operating an electronic game according to another embodiment of the present disclosure.

### DETAILED DESCRIPTION

Embodiments of the present disclosure are directed to low latency streaming of video in an electronic game such as an electronic table game. More specifically, embodiments are directed to reducing latency of a video stream capturing a playing surface and game elements, e.g., a table surface and pair of dice, and delivered to a player terminal device for viewing. This can be accomplished by offloading processing of the video stream from a processor, i.e., a Central Processing Unit (CPU), of the gaming system to a Graphics Processing Unit (GPU) of the system. The GPU can decode the video stream save the frames of the decoded stream in an internal ring buffer of the GPU without returning a decoded stream to the CPU. The a frame saved in the buffer, e.g., a middle frame from the ring buffer, can be selected by the CPU at an interval, i.e., a frame rate, that provides a seamless, jitter-free output stream to the player terminal devices and with a lower latency than solutions that rely on the CPU of the gaming system to receive the entire decoded stream from the GPU.

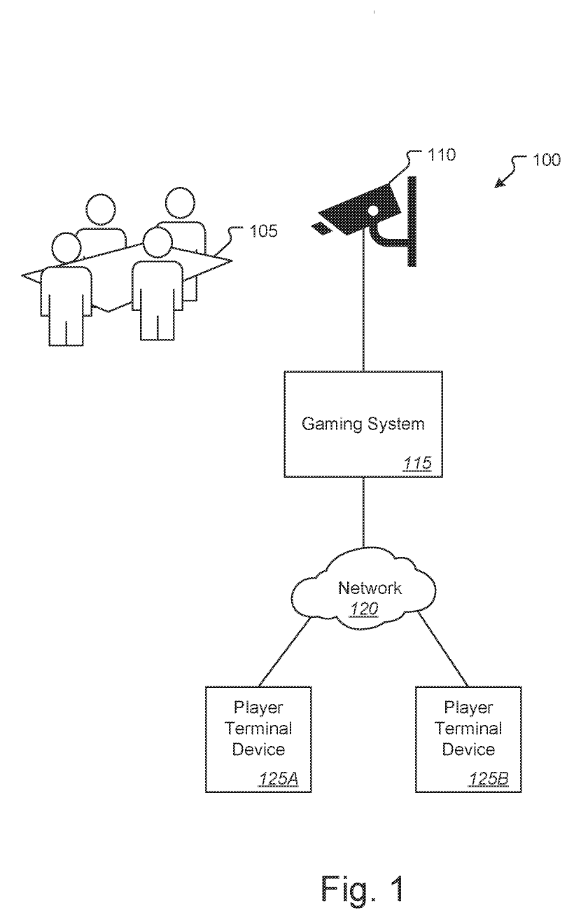

FIG. 1 is a block diagram illustrating an exemplary environment in which embodiments of the present disclosure may be implemented. As illustrated in this example, the environment 100 can comprise a gaming table 105, a camera 110 capturing a video stream representing a playing surface of and game elements on the gaming table 105, and a gaming system 115 receiving the video stream from the camera 110. The gaming system 115 can be coupled with a communications network 120. The communications network 115 can comprise any one or more wired and/or wireless, local-area and/or wide-area networks as known in the art including, but not limited to, the Internet. Also coupled with the communications network 120 can be any number of player terminal devices 125A-125B. The player terminal devices 125A-125B can comprise, for example, a touch-screen equipped computing device such as may be located in a casino or other gaming venue.

More specifically, the gaming system 115 can utilize the video stream from the camera 110 to provide an electronic game, e.g., an Electronic Table Game (ETG) to the player terminal device 125A-125B. For example, the table 105 can comprise a gaming table for craps, roulette, blackjack, etc. The gaming table 105 can comprise a real, mechanical device used to determine the outcome of a game. In another example, the gaming table can comprise a real-life gaming table at which a live dealer and one or more players are playing a live game. In either case, the gaming system 115 can receive a video stream of the gaming table 105 from the camera and provide the video stream to the player terminal devices 125A-125B. Through the player terminal devices 125A-125B, players can watch a representation of the ETG, place wagers, and participate in the ETG. Embodiments of the present disclosure are directed to providing the representation of the electronic game to the player terminal devices 125A-125B with low latency, thereby improving the player experience and encouraging participation in the electronic game.

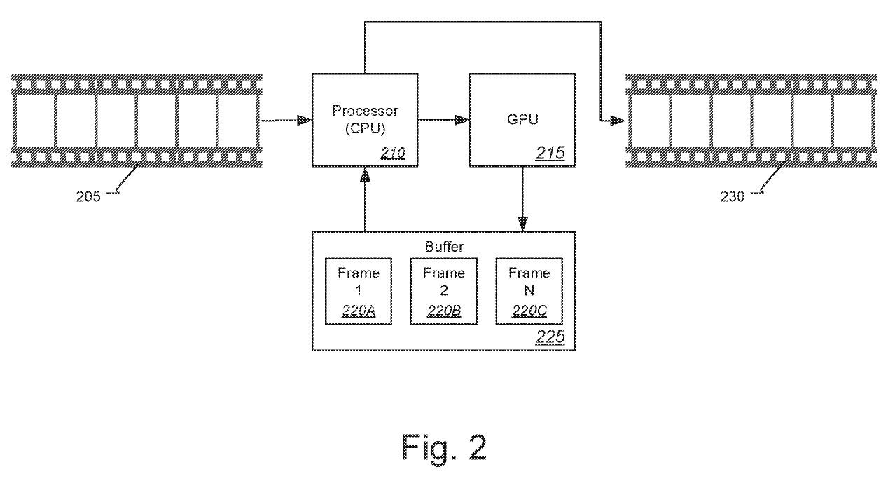

FIG. 2 is a block diagram illustrating additional details of elements of an environment in which embodiments of the present disclosure may be implemented according to one embodiment of the present disclosure. Generally speaking, and as illustrated in this example, an input video stream 205 from the camera 110 can be received by a processor, i.e., CPU, 210 of the gaming system 115. The CPU 210 can provide the input video stream 205 to a GPU 215 of the gaming system 115.

The GPU 215 can receive the input video stream 205 from the CPU 210, decode the input video stream 205, write the decoded frames 220A-220C into a buffer 225. It should be noted that while illustrated here as separate from the GPU 215, the buffer 225 can comprise an internal buffer of the GPU 215, i.e., within memory of the GPU 215 and not main memory of the gaming system 115. Additionally, it should be noted that while 3 frames 220A-220C are shown here for illustrative purposes, a different number of frames 220A-220C may be stored in the buffer 225 at any given moment. However, it should be noted that a larger buffer storing a larger number of frames can increase overall latency. According to one embodiment, the number of frames 220A-220C stored in the buffer 225 can comprise five frames. The buffer 225 can be implemented as a ring buffer, i.e., wherein the oldest frame is overwritten with the newest frame on an ongoing basis as the input stream 205 is decoded by the GPU 215.

Using the frames 220A-220C stored in the buffer 225, the CPU 210 can select one or more of the frames 220A-220C to provide as a next frame of an output video stream 230. For example, in the case of a ring buffer storing five frames, the CPU 215 can select a middle frame. This provides an additional possible two frames before or after the selected frame in case of speed fluctuations. The time between selecting the frames can be set to an amount of time that is imperceptible to the human eye, i.e., less than about 30 milliseconds. According to one embodiment, this amount of time can be 50 milliseconds.

In summary, decoding of the input video stream 205 by the GPU 215 into a relatively small, e.g., five frames, internal buffer 225 of the GPU 215 and using the frames within the internal buffer 225 to provide an output stream 230 by the CPU 210 negates the previous GPU 225 to CPU 210 transfer of the decoded stream and subsequent transfer back to the GPU 215 of the output stream. Thus embodiments described herein can provide very low latency streaming.

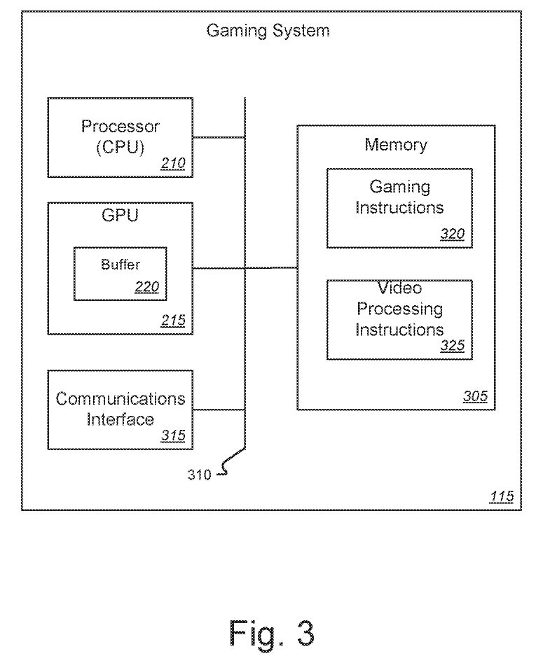

FIG. 3 is a block diagram illustrating additional details of components of a gaming system according to one embodiment of the present disclosure. As illustrated in this example, a gaming system 115 such as described above can comprise a processor 210. The processor 210 may correspond to one or many computer processing devices. For instance, the processor 210 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 210 may be provided as a microprocessor, Central Processing Unit (CPU), or plurality of microprocessors that are configured to execute the instructions sets stored in a memory 305. Upon executing the instruction sets stored in memory 305, the processor 210 enables various functions of the gaming system 115 as described herein.

The memory 305 can be coupled with and readable by the processor 210 via a communications bus 215. The memory 305 may include any type of computer memory device or collection of computer memory devices. Non-limiting examples of memory 305 include Random Access Memory (RAM), Read Only Memory (ROM), flash memory, Electronically-Erasable Programmable ROM (EEPROM), Dynamic RAM (DRAM), etc. The memory 305 may be configured to store the instruction sets depicted in addition to temporarily storing data for the processor 210 to execute various types of routines or functions.

The processor 210 can also be coupled with a GPU 215 as introduced above. Generally speaking and as known in the art, the GPU 215 can comprise processors as described above and/or other electronic circuit designed to process graphics such as images and/or video. The GPU 215 can accelerate graphics rendering and image processing by performing many mathematical calculations and/or other processes simultaneously. The GPU 215 can also comprise an internal buffer 225. The buffer 225 can comprise a small amount of memory for storing individual video frames as described herein. The GPU 215 can manage this buffer 225, for example, as a ring buffer in which the oldest frame stored therein is overwritten by the newest frame as video is being decoded.

The processor 210 can also be coupled with one or more communication interface(s) 220 and one or more input/output devices 225 via the communications bus 215. The communication interface(s) 220 can comprise, for example, an Ethernet, Bluetooth, WiFi, cellular, and/or other type of wired and/or wireless communications interface. Via the communication interface(s) 220, the gaming system 115 can communicate with other devices and/or systems, such as a camera 110 as described above either directly or through a communications network 115 as described above.

The memory 305 can store therein a set of gaming instructions 320 which, when executed by the processor 210, can cause the processor 210 to execute an electronic game including, but not limited to, an electronic table game such as craps or roulette. The gaming instructions can further cause the processor 210 to receive, from a camera 110, e.g., through communication interface 315, an encoded video stream 205 representing elements of an electronic game, and provide, to the GPU 215, the encoded video stream 205. For example, the electronic game can comprise an electronic table game and the encoded video stream can represent a table surface and other game elements.

A set of video processing instructions 325, when executed by the GPU 215, can cause the GPU 215 to receive the encoded video stream 205, decode the encoded video stream 205, and save the decoded frames 220A-220C from the video stream in a buffer 225 maintained within the GPU 215. The buffer 225 within the GPU 215 can comprise a fixed size ring buffer. For example, the fixed size can comprise five frames.

The gaming processing instructions 320 can further cause the CPU 210 to select a frame from the buffer and present the selected frame as a next frame of an output stream 230 of the gaming system 115, e.g., to player terminal devices 125A-125B via the communications interface 315 and network 120. A time between selected frames can be less than 30 milliseconds. For example, the time between selected frames can be 50 milliseconds.

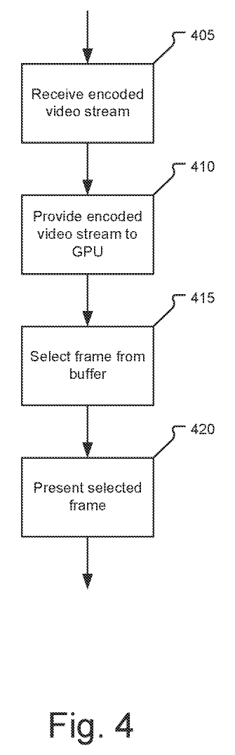

FIG. 4 is a flowchart illustrating an exemplary process for operating an electronic game according to one embodiment of the present disclosure. More specifically, this example illustrates processes as may be performed by the processor or CPU 210 as described above. As illustrated in this example, operating an electronic game can comprise receiving 405, by a CPU 210 of a gaming system 115, an encoded video stream 205 from a camera 110 of the gaming system. The encoded video stream 205 can represent elements of an electronic game. For example, the electronic game can comprise an electronic table game. The encoded video stream can be provided 410, by the CPU 210 of the gaming system 115, to a GPU 215 of the gaming system 115.

The CPU 210 can then select 415 a frame saved in a buffer 220 of the GPU 215. For example, the buffer can comprise a ring buffer storing five frames and the CPU 210 can select 415 the third, i.e., middle, frame from the buffer. The selected 415 frame can then be presented 420 if the game as an output stream. The period of time between selecting 415 and presenting 420 each successive frame of the output stream can be set to provide a jitter-free stream. For example, this time can be set to less than 30 milliseconds. According to one embodiment, the time between frames can be 50 milliseconds.

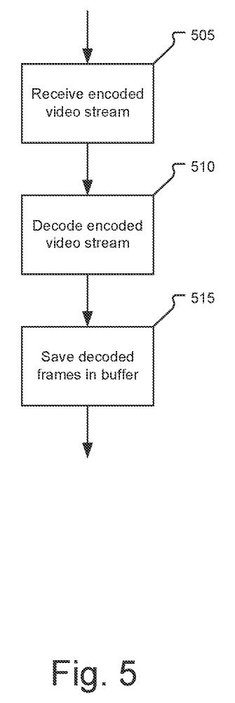

FIG. 5 is a flowchart illustrating an exemplary process for operating an electronic game according to another embodiment of the present disclosure. More specifically, this example illustrates processes as may be performed by the GPU 215 as described above. As illustrated in this example, operating an electronic game can comprise receiving 505 the encoded video stream 205 from the CPU 210 and decoding 510 the encoded video stream 205. Each frame of the decoded 510 video stream can then be saved 515 in an internal buffer 220 of the GPU 215. As noted above, the buffer 220 can be implemented as a ring buffer of a fixed size, e.g., five frames. In such cases, saving 515 saving each frame of the decoded video stream can comprise overwriting the oldest saved frame with the newest decoded frame.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

WHAT IS CLAIMED IS:

1. A gaming system comprising:
a Central Processing Unit (CPU);
a Graphics Processing Unit (GPU); and
a memory coupled with and readable by the CPU and the GPU and storing therein a set of instructions which, when executed by the CPU, causes the CPU to:
receive, from a camera, an encoded video stream representing elements of an electronic game, and
provide, to the GPU, the encoded video stream, and
wherein the set of instructions, when executed by the GPU, causes the GPU to:
receive the encoded video stream from the CPU,
decode the encoded video stream, and
save frames of the decoded video stream in a buffer maintained within the GPU.

2. The gaming system of claim 1, wherein the instructions further cause the CPU to select a frame from the buffer and provide the selected frame as a frame of an output stream of the electronic game.

3. The gaming system of claim 2, wherein the buffer within the GPU comprises a ring buffer of a fixed size.

4. The gaming system of claim 3, wherein the fixed size comprises five frames.

5. The gaming system of claim 2, wherein a time between providing the selected frame as a frame of an output stream of the electronic game is less than 30 milliseconds.

6. The gaming system of claim 5, wherein the time between provide the selected frame as a frame of an output stream of the electronic game is 50 milliseconds.

7. The gaming system of claim 1, wherein the electronic game comprises an electronic table game.

8. An Electronic Table Game (ETG) system comprising:
a Central Processing Unit (CPU);
a Graphics Processing Unit (GPU); and
a memory coupled with and readable by the CPU and the GPU and storing therein a set of instructions which, when executed by the CPU, causes the CPU to:
receive, from a camera, an encoded video stream representing elements of an electronic game, and
provide, to the GPU, the encoded video stream, and
wherein the set of instructions, when executed by the GPU, causes the GPU to:
receive the encoded video stream from the CPU,
decode the encoded video stream, and
save frames of the decoded video stream in a buffer maintained within the GPU.

9. The ETG system of claim 8, wherein the instructions further cause the CPU to select a frame from the buffer and provide the selected frame as a frame of an output stream of the electronic game.

10. The ETG system of claim 9, wherein the buffer within the GPU comprises a ring buffer of a fixed size.

11. The ETG system of claim 10, wherein the fixed size comprises five frames.

12. The ETG system of claim 9, wherein a time between providing the selected frame as a frame of an output stream of the electronic game is less than 30 milliseconds.

13. The ETG system of claim 5, wherein the time between provide the selected frame as a frame of an output stream of the electronic game is 50 milliseconds.

14. A method for operating an electronic game, the method comprising:
receiving, by a Central Processing Unit (CPU) of a gaming system, from a camera, an encoded video stream representing elements of an electronic game;
providing, by the CPU of the gaming system, to a Graphics Processing Unit (GPU) of the gaming system, the encoded video stream;
receiving, by the GPU of the gaming system, the encoded video stream from the CPU;
decoding, by the GPU of the gaming system, the encoded video stream; and
saving, by the GPU of the gaming system, frames of the decoded video stream in a buffer maintained within the GPU.

15. The method of claim 14, further comprising:
selecting, by the CPU of the gaming system, a frame from the buffer; and
providing, by the CPU of the gaming system, the selected frame as a frame of an output stream of the electronic game.

16. The method of claim 15, wherein the buffer within the GPU comprises a ring buffer of a fixed size.

17. The method of claim 16, wherein the fixed size comprises five frames.

18. The method of claim 15, wherein a time between providing the selected frame as a frame of an output stream of the electronic game is less than 30 milliseconds.

19. The method of claim 18, wherein the time between provide the selected frame as a frame of an output stream of the electronic game is 50 milliseconds.

20. The method of claim 14, wherein the electronic game comprises an electronic table game.
